(19) United States
(12) Patent Application Publication
(10) Pub. No.: US 2016/0156773 A1
(43) Pub. Date: Jun. 2, 2016

(54) DYNAMICALLY UPDATING ROUTE IN NAVIGATION APPLICATION IN RESPONSE TO CALENDAR UPDATE

(71) Applicant: BlackBerry Limited, Waterloo (CA)

(72) Inventor: Rupen CHANDA, San Francisco, CA (US)

(21) Appl. No.: 14/555,847

(22) Filed: Nov. 28, 2014

(51) Int. Cl. H04M 1/725; H04W 4/02

(52) U.S. Cl. CPC H04M 1/72566; H04W 4/025

(57) ABSTRACT

A method of dynamically updating a route entails receiving a calendar update for a calendar event of a calendar application on a mobile device, the calendar update specifying an updated destination location, transferring the updated destination location to a navigation application, recalculating the route to the updated destination location, and presenting navigation output based on the updated destination location. This may be used for outdoor navigation, indoor navigation or both.

### TECHNICAL FIELD

The present disclosure relates to computer-aided navigation technologies.

### BACKGROUND

A mobile device having a calendar application (or agenda or scheduler) enables a user of the mobile device to schedule appointments, meetings or events. The calendar application may interact with an e-mail application to send and receive meeting requests and to send and receive updates (hereinafter “calendar updates”) specifying a change in the time or location of an appointment or event.

### BRIEF DESCRIPTION OF THE DRAWINGS

Further features and advantages of the present technology will become apparent from the following detailed description, taken in combination with the appended drawings, in which:

FIG. 1 is a depiction of an example mobile device in accordance with one embodiment of the present disclosure;

FIG. 2 is a depiction of an example system including a mobile device and a portable navigation device in accordance with another embodiment of the present disclosure;

FIG. 3 is a depiction of another example system including a mobile device and an in-dash navigation unit of a vehicle in accordance with yet another embodiment of the present disclosure;

FIG. 4 is a depiction of the system of FIG. 3 proposing a new start time after determining that there is insufficient time to travel to a subsequent event location from the updated destination location;

FIG. 5 is a depiction of the mobile device of FIG. 1 presenting various optional actions after determining that there is insufficient time to travel to a subsequent event location from the updated destination location; and

FIG. 6 is a flowchart of a method of dynamically updating a route in a navigation application in response to a calendar update.

It will be noted that throughout the appended drawings, like features are identified by like reference numerals.

### DETAILED DESCRIPTION

If a calendar update is sent while a user is driving to an appointment, meeting or event, the user is unlikely to see the calendar update. Even if the user becomes aware of the calendar update, it is difficult or inconvenient for the user to program a new destination location into the navigation system that is guiding the user to the location of the appointment or event.

The present disclosure provides a technique for dynamically updating a route in a navigation application in response to a calendar update. This technology may be implemented in a mobile device having both a calendar application and a navigation application. Alternatively, this technology may be implemented in a navigation system that includes both a mobile device having a calendar application and a portable navigation device that is able to communicate with the mobile device. As a further alternative, this technology may be implemented in a navigation system that includes both a mobile device having a calendar application and an in-dash navigation unit that is able to communicate with the mobile device.

Accordingly, one aspect of the present disclosure is a method of dynamically updating a route. The method entails receiving a calendar update for a calendar event of a calendar application on a mobile device, the calendar update specifying an updated destination location, transferring the updated destination location to a navigation application, recalculating the route to the updated destination location, and presenting navigation output based on the updated destination location.

Another aspect of the present disclosure is a non-transitory computer-readable medium comprising instructions in code which when loaded into a memory and executed by a processor of a navigation device cause the navigation device to receive a calendar update for a calendar event of a calendar application, the calendar update specifying an updated destination location, transfer the updated destination location to a navigation application of the navigation device, recalculate the route to the updated destination location, and present navigation output based on the updated destination location.

Another aspect of the present disclosure is a mobile device that includes a memory operatively coupled to a processor for storing and executing a calendar application that stores a calendar event having a destination location associated with the calendar event. The mobile device includes a radiofrequency transceiver for receiving a calendar update specifying an updated destination location. The processor causes the mobile device to transfer the updated destination location to a navigation application that recalculates the route to the updated destination location and presents navigation output based on the updated destination location.

The details and particulars of these aspects of the technology will now be described below, by way of example, with reference to the drawings.

### Mobile Device Executing Navigation Application

In general, this technology may be implemented by a mobile device, e.g., a mobile communications device, wireless communications device, tablet, personal digital assistant, cell phone, smart phone, smart watch, smart accessory, gaming device or any other portable electronic device or portable communication device that includes a processor and memory for executing a calendar application, a Global Positioning System (GPS) or Global Navigation Satellite System (GNSS) receiver for determining a current location of the mobile device and a navigation application for calculating a route to a destination location.

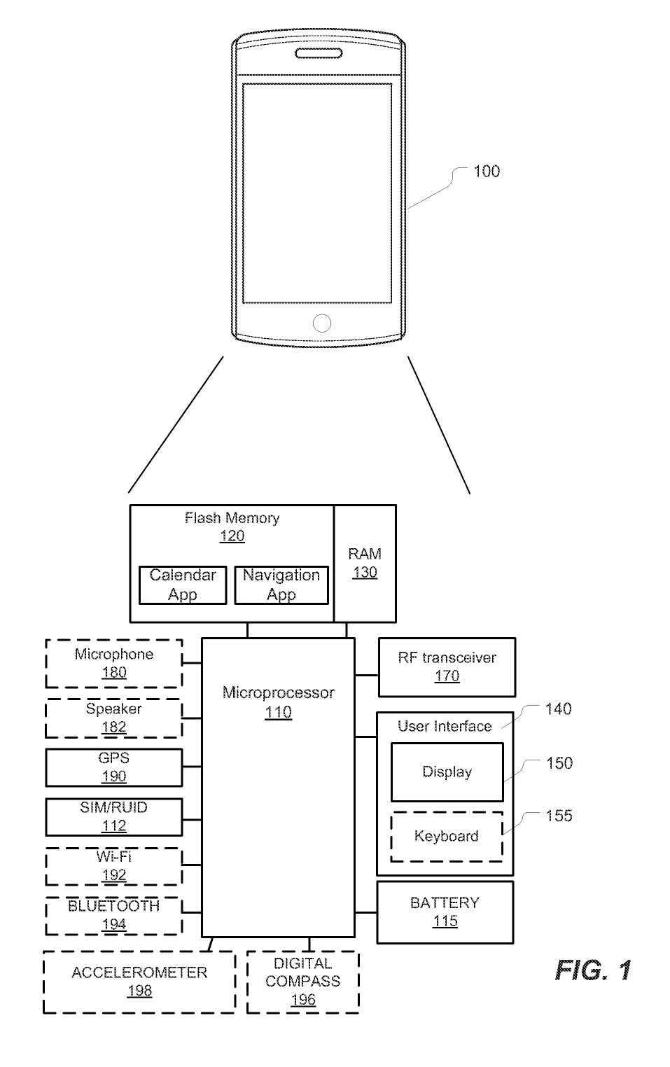

FIG. 1 is a depiction of one example of a mobile device that may be used to implement the present technology. In this embodiment, the mobile device is the navigation device. Both the calendar application and the navigation application reside on the mobile device. The mobile device, which is generally designated by reference numeral 100, includes a processor 110 and memory 120, 130 for executing one or more applications such as the calendar application and the navigation application. The memory may include flash memory 120 and/or random access memory (RAM) 130. Other types or forms of memory may be used. The mobile device may be powered by a rechargeable battery 115.

As depicted by way of example in FIG. 1, the mobile device 100 includes a user interface 140 for interacting with the mobile device and its applications. The user interface 140 may include one or more input/output devices, such as a display screen 150 (e.g. an LCD, LED or OLED touch-sensitive display screen), and may optionally include a keyboard or keypad. The user interface may also include an optical jog pad and/or a thumbwheel, trackball, track pad or equivalent.

As depicted by way of example in FIG. 1, the mobile device 100 may include a cellular radiofrequency (RF) transceiver 170 for communicating with other devices. The cellular radiofrequency transceiver 170 enables wireless communication with one or more base stations over a cellular wireless network using cellular communication protocols and standards for both voice calls and packet data transfer such as GSM, CDMA, GPRS, EDGE, UMTS, LTE, etc. For example the mobile device 100 connects to a cellular network via a base transceiver station (BTS), base station controller (BSC), Serving GPRS Support Node (SGSN), and Gateway GPRS Support Node (GGSN). In an LTE implementation, the mobile device connects via eNode B (base station), mobility management entity (MME) and serving gateway (SGW).

The mobile device 100 may include a Subscriber Identity Module (SIM) card 112 for GSM-type devices or a Re-Usable Identification Module (RUIM) card for CDMA-type devices. The RF transceiver 170 may include separate voice and data channels.

The mobile device 100 may also include one or more ports for wired connections, e.g. USB, HDMI, FireWire (IEEE 1394), etc.

The mobile device 100 optionally includes a speech-recognition subsystem that has a microphone 180 for transforming voice input in the form of sound waves into an electrical signal. Optionally, the mobile device 100 may include a speaker 182 and/or an earphone jack.

The mobile device 100 includes a position-determining subsystem such as a Global Navigation Satellite System (GNSS) receiver, for example a Global Positioning System (GPS) receiver 190 (e.g. in the form of a chip or chipset) for receiving GNSS (e.g. GPS) radio signals transmitted from one or more orbiting GNSS (e.g. GPS) satellites. Although the present disclosure refers expressly to the Global Positioning System, it should be understood that this term and its abbreviation “GPS” are being used expansively to include any GNSS or satellite-based navigation-signal broadcast system, and would therefore include other systems used around the world including the Beidou (COMPASS) system being developed by China, the multi-national Galileo system being developed by the European Union, in collaboration with China, Israel, India, Morocco, Saudi Arabia and South Korea, Russia's GLONASS system, India's proposed Regional Navigational Satellite System (IRNSS), and Japan's proposed QZSS regional system.

The mobile device 100 includes a Wi-Fi transceiver 192 (which may, in some embodiments, be just a Wi-Fi receiver) for receiving a Wi-Fi signal transmitted by a Wi-Fi access point, router, adapter or hotspot. Although Wi-Fi® is a registered trademark of the Wi-Fi Alliance, it shall be identified simply as “Wi-Fi” in this specification. Wi-Fi encompasses the IEEE 802.11 standard and all its drafts and amendments.

The mobile device 100 optionally includes a Bluetooth® transceiver 194, and/or a near-field communications (NFC) chip. The mobile device 100 may also optionally include a transceiver for WiMax™ (IEEE 802.16), a transceiver for ZigBee® (IEEE 802.15.4-2003 or other wireless personal area networks), an infrared transceiver or an ultra-wideband transceiver.

Optionally, the mobile device may include other sensors like a digital compass 196 and/or accelerometer 198. Other sensors may include a tilt sensor, gyroscope or equivalent.

The mobile device 100 executes both the calendar application and the navigation application using the processor 110 of the mobile device. The memory 120, 130 stores both the calendar application and the navigation application. In operation, the mobile device 100 receives a calendar update, e.g. via e-mail or by any equivalent communication means. The calendar update specifies an updated destination location. In response to receiving the calendar update, the processor transfers the data representing the calendar update via one or more internal data buses to the navigation application to enable the navigation application to dynamically update the route to the updated destination location. The route is dynamically recalculated using the updated destination location. Optionally, one or more visual and/or audible notifications may be presented to alert the user to the change in routing. This obviates the need for the user to monitor the mobile device for any calendar updates and also saves the trouble of having to enter a new destination into the navigation application. These tasks are especially problematic when driving.

### Mobile Device Connected to Portable Navigation Device

In another embodiment, the mobile device 100 is communicatively connected to a portable navigation device (PND) 200. A PND comprises any self-contained GNSS-based navigation device that can be temporarily mounted (e.g. via a suction cup mounting apparatus or other holding mechanism) to the inner surface of a windshield or on the upper surface of a dashboard of a vehicle. In the illustrated embodiment, the PND includes a microprocessor 210, a memory 220 storing maps and a POI database (e.g. a database of geocoded hotels, restaurants, gas stations, shops, landmarks, theme parks, etc.), a display screen 250, e.g. an LCD, LED, or OLED touchscreen display, a speaker 280, a GNSS (e.g. GPS) receiver chipset 290, a battery 215, a power connector 218 and a data communication interface 270. The data communication interface may comprise a wired data communication interface like a USB connector or a wireless data communication interface such as a short-range wireless communication transceiver that provides a data communication link with the mobile device. The short-range wireless transceiver may be, for example a Bluetooth® transceiver for wirelessly connecting to (“pairing with”) the mobile device.

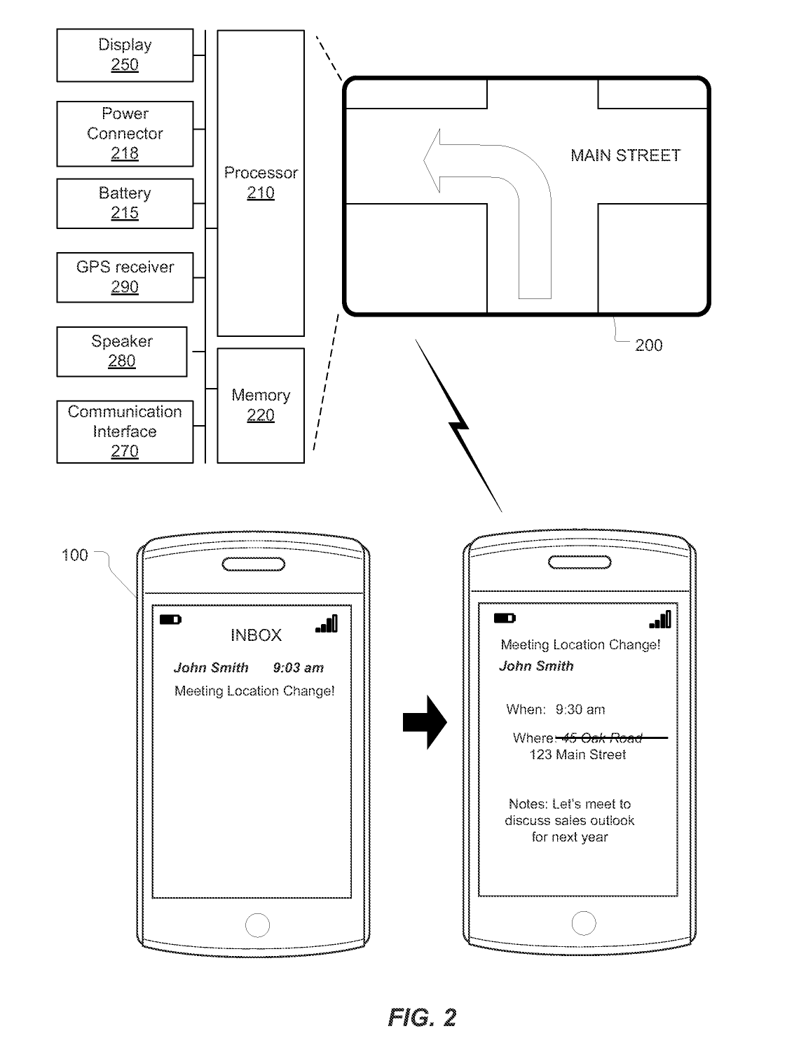

In the embodiment depicted by way of example in FIG. 2, the mobile device 100 executes the calendar application whereas the navigation application is executed by the PND 200. The PND 200 stores the navigation application in its memory 220 and executes the navigation application using its processor 210. For the purposes of this specification, “navigation application” includes any software, program, module, component or machine-executable code or instruction set that provides a navigation function, i.e. receives input specifying a destination location, computes a route to the destination location and displays a map and provides audible navigation instructions to guide the user to the destination location. The PND may also store and execute other applications such as hands-free calling, music, mileage tracking, etc.

In operation, the mobile device 100 receives a calendar update, e.g. via e-mail or by any equivalent electronic communication means, and transfers the calendar update via the wireless communication link to the navigation application on the PND to enable the navigation application of the PND to dynamically update the route to the updated destination location. The calendar update causes the calendar application to update the event data. The calendar update may be reformatted prior to being transferred to the PND to be in a format readable by the navigation application.

This embodiment also obviates the need for the user to monitor the mobile device for any calendar updates and also saves the trouble of having to enter a new destination into the navigation application.

### Mobile Device Connected to In-Dash Navigation Unit

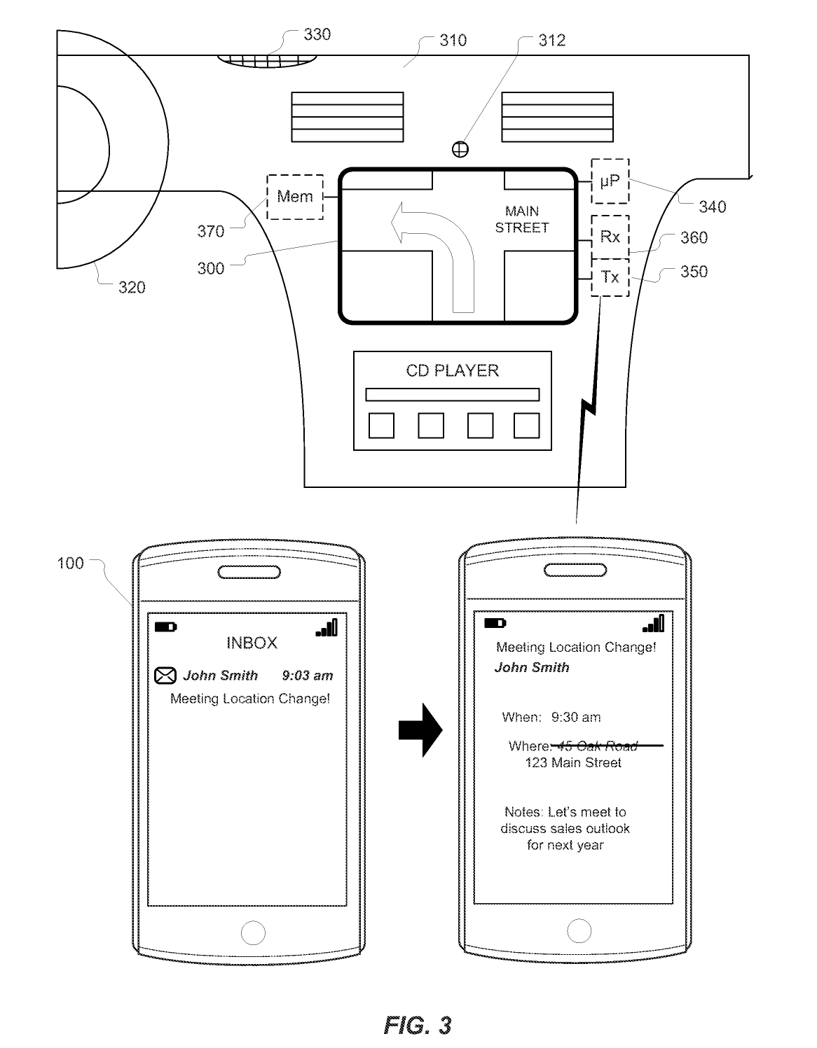

In yet another embodiment, the mobile device 100 is connected to an in-dash navigation unit (IDNU) 300 of a vehicle such as an automobile, truck, watercraft, aircraft, etc. The vehicle's in-dash navigation unit 300 comprises a GNSS-based navigation device that is permanently installed in a dashboard 310 or console of a vehicle. FIG. 3 shows an example layout of a vehicle dashboard 310 with the IDNU 300 placed in a central console to the right of a steering wheel 320.

The in-dash navigation unit may include an LCD, LED or OLED touchscreen powered by an electrical system of the vehicle and an internal GPS chip. User commands may be input directly on the touchscreen or using other user input devices in the vehicle. A microphone 312 may be provided to receive voice commands. Audible navigation instructions may be output via the speaker(s) 330 of the vehicle.

The IDNU 300 stores navigation program code of a navigation program, map data and POI data in a memory 370. A processor 340 executes the navigation program (generically referred to herein as a “navigation application”) to calculate a route, display a map and present audible instructions.

The in-dash navigation unit may have a wireless communication link, e.g. provided by a Bluetooth® transceiver, for wirelessly connecting to (“pairing with”) a mobile device. For the wireless link the IDNU 300 may have a short-range transmitter 350 and a short-range receiver 360. Alternatively, the in-dash navigation unit may share a central vehicle wireless link for data exchange with the mobile device. It will be appreciated that the IDNU may be part of a multi-purpose vehicle computer system that uses a single display screen to provide various vehicle functions such as sound system management, trip computer, etc.

In the embodiment depicted by way of example in FIG. 3, the mobile device 100 executes the calendar application whereas the navigation application is executed by the vehicle in-dash navigation unit 300. The mobile device 100 receives a calendar update, e.g. via e-mail or by any equivalent means, and transfers the calendar update via the wireless communication link to the navigation application on the vehicle to permit the navigation application of the vehicle to dynamically update the route to the updated destination location. This embodiment also obviates the need for the user to monitor the mobile device for any calendar updates and also saves the trouble of having to enter a new destination into the navigation application.

In another embodiment, the memory and processor of the in-dash navigation unit may be configured to store and process code of a calendar application capable of displaying calendar events, providing reminders, and performing other calendar-related tasks. In this embodiment, the calendar application can transfer a calendar update to the navigation application to update the destination location and hence the route.

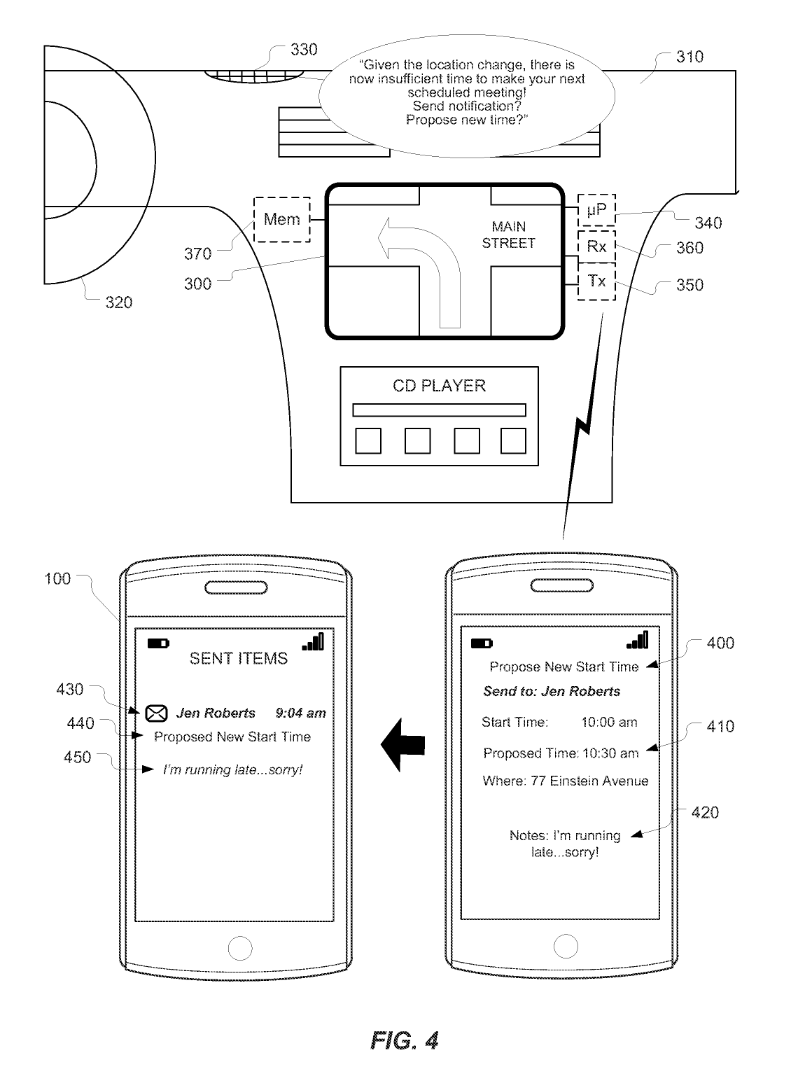

FIG. 4 shows how one embodiment of the system of FIG. 3 can propose a new start time after determining that there is insufficient time to travel to a subsequent event location from the updated destination location. In this example, the IDNU 300 may output an audible alert or notification, e.g. “Given the location change, there is now insufficient time to make your next scheduled meeting! Send notification? Propose new time?” The user can reply with a voice command (or other user input) to instruct the system to propose a new start time. FIG. 4 shows a mobile device 100 displaying a user interface showing that a new start time 400 is being proposed. The IDNU may calculate an appropriate start new or may prompt the user to specify a new start time. In this example, the mobile device proposes a new start time (“proposed time”) 410 of 10:30 a.m. to supersede the originally scheduled 10:00 a.m. start time. Optionally, the IDNU or mobile device may prompt the user to dictate a personal message or notes 420, e.g. “I'm running late . . . sorry!” The mobile device 100 may then send the proposal for the new start time, e.g. via e-mail or other means. In this example, the mobile device sends the proposal via e-mail and this sent e-mail 430 is then shown in the Sent Items folder of the e-mail application. The Sent Items show the subject 440 “Proposed New Start Time” and the message content or body 450 (taken from the dictated notes).

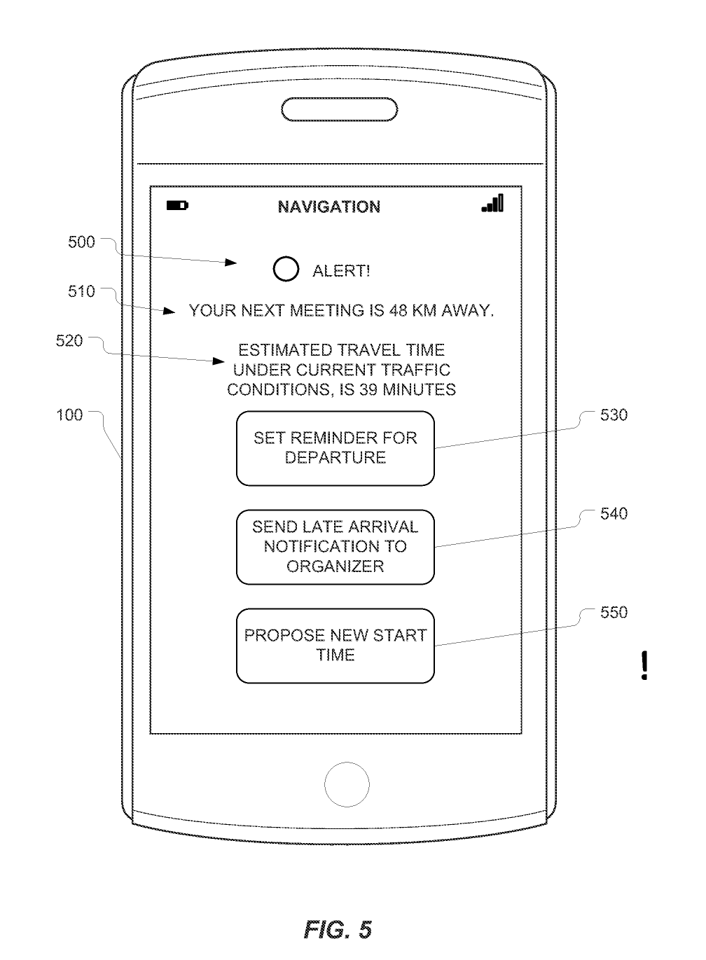

FIG. 5 is a depiction of the mobile device 100 of FIG. 1 presenting various optional actions after determining that there is insufficient time to travel to a subsequent event location from the updated destination location. The mobile device 100 may present an alert 500, visually and/or audibly. For example, the alert may indicate a distance 510 to the next meeting (subsequent event). Optionally, the alert may include an estimated travel time under current traffic conditions. Various user actions may be presented, e.g. set reminder for departure 530, send late arrival notification to organizer 540 and/or propose new start time 550. Other actions may be presented.

### Method

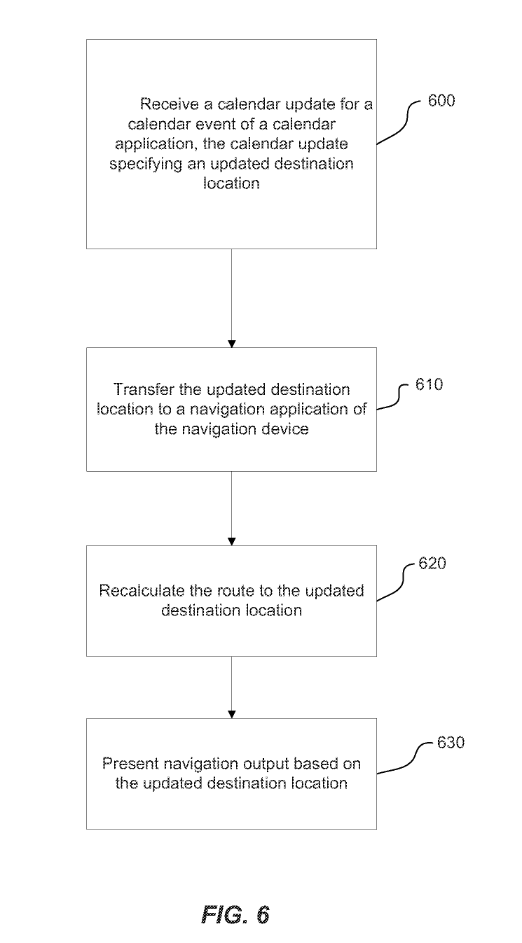

A method of dynamically updating a route is disclosed by way of example in FIG. 6. As depicted in the flowchart of FIG. 6, the method entails steps, acts or operations of receiving (600) a calendar update for a calendar event of a calendar application on a mobile device, the calendar update specifying an updated destination location, transferring (610) the updated destination location to a navigation application, recalculating (620) the route to the updated destination location, and (630) presenting navigation output based on the updated destination location.

In one implementation of the method, receiving the calendar update involves receiving an e-mail calendar update by a calendar application of a mobile device. In this implementation of the method, transferring the destination location involves providing the destination location received by the calendar application to a navigation application on the mobile device.

In another implementation of the method, receiving the calendar update involves receiving an e-mail calendar update by a calendar application of a mobile device. In this other implementation of the method, transferring involves communicating the calendar update from the mobile device to a portable navigation device (PND), e.g. to a navigation application running on the PND.

In another implementation of the method, receiving the calendar update involves receiving an e-mail calendar update by a calendar application of a mobile device. In this other implementation of the method, transferring involves communicating the calendar update from the mobile device to an in-dash navigation unit (IDNU) of a vehicle, e.g. to a navigation application running on the IDNU.

The method may be refined by computing an estimated travel time from the destination location to a subsequent event location of a subsequent event stored by the calendar application and generating output based on the travel time to the subsequent event location if the travel time exceeds a travel time threshold. Alternatively, the method may involve computing an arrival time and generating output if the arrival time is later than an arrival time threshold, which may be based on a start time of the subsequent event. The output may include outputting an earlier departure time based on the estimated travel time to the subsequent event location. Alternatively, the output may involve sending a request for a new start time to the organizer of the subsequent event. Alternatively, the output may involve sending a late arrival notification to the organizer and/or to the attendees of the subsequent event.

In another implementation, the calendar update may be generated by transcribing a voice call using a speech-to-text module, by parsing transcribed text of the voice call for an indication that the destination location has changed and providing this update to the calendar as a calendar update.

Although the technology described above may be used in outdoor navigation, this technology may be particularly useful in the context of indoor navigation and may also be used in the context of mixed indoor-outdoor navigation. For indoor navigation, where the mobile device cannot receive GNSS satellite signals of sufficient strength to obtain a position fix, the mobile device may use an indoor positioning system (IPS) that relies on distance measurements to known indoor positions. These indoor positions may comprise, for example, the positions of Wi-Fi access points, Bluetooth transmitters, RFID tags, TransferJet couplers, near field communication (NFC) readers or any other suitable wireless technology. Dead reckoning may also be used for indoor navigation. An IPS may be useful when the mobile device is navigating in an indoor or shielded environment, e.g. for guiding a user to an indoor meeting location. This may be useful when the meeting location is in a corporate setting, hospital, university or other school, government building, convention center, hotel or other indoor location having a number of meeting rooms. In such a case, a notification advising of a change in meeting location is used by the mobile device to automatically update the route provided by the navigation application to the indoor meeting location.

Any of the methods disclosed herein may be implemented in hardware, software, firmware or any combination thereof. Where implemented as software, the method steps, acts or operations may be programmed or coded as computer-readable instructions and recorded electronically, magnetically or optically on a fixed, permanent, non-volatile or non-transitory computer-readable medium, computer-readable memory, machine-readable memory or computer program product. In other words, the computer-readable memory or computer-readable medium comprises instructions in code which when loaded into a memory and executed on a processor of a computing device cause the computing device to perform one or more of the foregoing method(s).

A computer-readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc.

The use of the terms “a” and “an” and “the” and similar referents in this specification are to be construed to cover both the singular and the plural, unless otherwise indicated or clearly implied by the context. The terms “comprising”, “having” and “including” are to be construed as open-ended terms (i.e. meaning “including, but not limited to,”) unless otherwise noted.

This invention has been described in terms of specific embodiments, implementations and configurations which are intended to be examples only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. A method of dynamically updating a route, the method comprising:
receiving a calendar update for a calendar event of a calendar application on a mobile device, the calendar update specifying an updated destination location;
transferring the updated destination location to a navigation application;
recalculating the route to the updated destination location; and
presenting navigation output based on the updated destination location.

2. The method as claimed in claim 1 wherein receiving the calendar update comprises receiving an e-mail calendar update by a calendar application of a mobile device and wherein transferring the destination location comprises providing the destination location received by the calendar application to a navigation application on the mobile device.

3. The method as claimed in claim 1 wherein receiving the calendar update comprises receiving an e-mail calendar update by a calendar application of a mobile device and wherein transferring comprises communicating the calendar update from the mobile device to a portable navigation device.

4. The method as claimed in claim 1 wherein receiving the calendar update comprises receiving an e-mail calendar update by a calendar application of a mobile device and wherein transferring comprises communicating the calendar update from the mobile device to an in-dash navigation unit of a vehicle.

5. The method as claimed in claim 1 further comprising:
computing an estimated travel time from the destination location to a subsequent event location or an estimated arrival time at the subsequent event location of a subsequent event stored by the calendar application; and
generating output based on the estimated travel time to the subsequent event location if the travel time exceeds a travel time threshold or based on the estimated arrival time at the subsequent event location if the estimated arrival time is later than an arrival time threshold.

6. The method as claimed in claim 5 wherein generating the output comprises outputting an earlier departure time based on the estimated travel time to the subsequent event location or based on the estimated arrival time at the subsequent event location.

7. The method as claimed in claim 5 wherein the generating the output comprises sending a request for a new start time for the subsequent event.

8. The method as claimed in claim 5 wherein the generating the output comprises sending a late arrival notification to an organizer of the subsequent event.

9. A non-transitory computer-readable medium comprising instructions in code which when loaded into a memory and executed by a processor of a navigation device cause the navigation device to:
receive a calendar update for a calendar event of a calendar application, the calendar update specifying an updated destination location;
transfer the updated destination location to a navigation application of the navigation device;
recalculate the route to the updated destination location; and
present navigation output based on the updated destination location.

10. The computer-readable medium as claimed in claim 9 wherein the navigation device comprises a mobile device comprising code for receiving an e-mail calendar update and for transferring the destination location to the navigation application on the mobile device.

11. The computer-readable medium as claimed in claim 9 wherein the navigation device is a portable navigation device that receives the destination location from a mobile device having the calendar application.

12. The computer-readable medium as claimed in claim 9 wherein the navigation device is an in-dash navigation unit in a vehicle that receives the destination location from a mobile device having the calendar application.

13. The computer-readable medium as claimed in claim 9 further comprising code that causes the navigation device to:
compute an estimated travel time from the destination location to a subsequent event location or an estimated arrival time at the subsequent event location of a subsequent event stored by the calendar application; and
generate output based on the estimated travel time to the subsequent event location if the travel time exceeds a travel time threshold or based on the estimated arrival time at the subsequent event location if the estimated arrival time is later than an arrival time threshold.

14. A mobile device comprising:
a memory operatively coupled to a processor for storing and executing a calendar application that stores a calendar event having a destination location associated with the calendar event; and
a radiofrequency transceiver for receiving a calendar update specifying an updated destination location;
wherein the processor causes the mobile device to transfer the updated destination location to a navigation application that recalculates the route to the updated destination location and presents navigation output based on the updated destination location.

15. The mobile device as claimed in claim 14 wherein the radiofrequency transceiver receives an e-mail calendar update and wherein the navigation application is also executed by the processor of the mobile device.

16. The mobile device as claimed in claim 14 wherein the radiofrequency transceiver receives an e-mail calendar update and wherein the navigation application is executed by a portable navigation device communicatively connected to the mobile device.

17. The mobile device as claimed in claim 14 wherein the radiofrequency transceiver receives an e-mail calendar update and wherein the navigation application is executed by an in-dash navigation unit of a vehicle communicatively connected to the mobile device.

18. The mobile device as claimed in claim 14 wherein the processor is configured to:
compute an estimated travel time from the destination location to a subsequent event location or an estimated arrival time at the subsequent event location of a subsequent event stored by the calendar application; and
generate output based on the estimated travel time to the subsequent event location if the travel time exceeds a travel time threshold or based on the estimated arrival time at the subsequent event location if the estimated arrival time is later than an arrival time threshold.

19. The mobile device as claimed in claim 18 wherein the processor is configured to perform one or more of the following:
outputting an earlier departure time based on the estimated travel time to the subsequent event location or based on the estimated arrival time at the subsequent event location;
sending a request for a new start time for the subsequent event;
sending a late arrival notification to an organizer of the subsequent event.

20. The mobile device as claimed in claim 14 further comprising a microphone for recording voice signals and for providing the voice signals to a speech-to-text module executed by the processor for transcribing a voice call and for parsing transcribed text of the voice call for an updated destination location and for generating the calendar update.
